(19) United States
(12) Patent Application Publication
(10) Pub. No.: US 2020/0163321 A1
(43) Pub. Date: May 28, 2020

(54) Power Jigger Adaptable to Existing Rod Holder

(71) Applicant: Alfred Franklin Nibecker, Honokaa, HI (US)

(72) Inventor: Alfred Franklin Nibecker, Honokaa, HI (US)

(21) Appl. No.: 16/673,593

(22) Filed: Nov. 4, 2019

Related U.S. Application Data
(60) Provisional application No. 62/771,286, filed on Nov. 26, 2018.

(51) Int. Cl. A01K 97/10; A01K 97/01

(52) U.S. Cl. CPC A01K 97/10; A01K 97/01

(57) ABSTRACT

The present invention generally relates to a mechanical assembly which induces a back-and-forth motion to a fishing lure or bait. Where past such devices primarily accomplished this action by oscillating a fishing rod, the present invention simply oscillates the fishing line. In the few instances where prior art oscillated the fishing line, the designs required the vessel to be altered to accept the mounting of the design. The present invention demonstrates how a standard cylindrical rod holder found on most fishing vessels can be used to provide a secure mount for the invention. The present invention discloses an equipment base which supports a motor and electrical switch and which may be rotated to avoid obstructions while, along with a wand, positioned to obtain optimum performance. Lastly, the present invention presents a unique method for adjusting the output pulling force to match the requirements of the lure or bait being pulled.

### BACKGROUND OF THE INVENTION

When attempting to catch fish with either a fishing lure or bait, it, is most often advantageous to cause the bait or lure to be in continuous motion. This may be accomplished simply by dragging the bait or lure through the water behind a boat (known as ‘trolling’). Alternately, the operator may simply pull the fishing line backward and forward, or up and down to instill the desired movement to the lure or bait. This pulling and releasing process is repeated about every 1-2 seconds and is normally applied continuously over a period of time. Applying fairly constant rhythmic motion to the lure or bait in such a manner is termed ‘Jigging’. Jigging is normally accomplished by the operator simply raising and lowering the tip of the fishing rod, imparting the desired movement to the lure or bait. However, over time this will prove tiring to even the most ardent fisherman.

For the ice fisherman fishing through a hole in the ice to the power boater trolling on lake, numerous devices have been presented which attempt to produce the jigging affect while fishing. Almost all of these devices employ a specially designed bracket to hold the fishing rod near the rod's base. A mechanical means is then employed to oscillate the bracket and hence the fishing rod, imparting the desired jigging motion to the lure or bait attached to the fishing rod's fishing line. A substantial portion of the energy produced by the motor drive for these units is wasted in moving the weight of the fishing rod back and forth. It would be totally impractical to try to use one of these devices with the heavy rod/reel combinations currently in use for landing large ocean fish. Therefore, these existing devices are always employed when fishing for relatively small fish. While jigging is very advantageous for really large fish like blue marlin, the present art is confined to fish weighing just a few pounds. Indeed, a blue marlin strike would rip the present art right out of its mounting.

U.S. Pat. Nos. 6,363,650 and 4680,885 propose jigging systems which attach directly to the fishing line to accomplish required jigging. In U.S. Pat. No. 6,363,650 a jigging device is mounted adjacent to the fishing rod and an attachment to the fishing line is made just past the fishing reel which pulls the fishing line backward and forward. However, this has the disadvantage of pulling the fishing line continually backward and forward over the rings in the rod which direct the line along the rod length. With time, the line will wear and snap when so exposed. Both devices still require some method of securing the fishing rod, although U.S. Pat. No. 4,680,885 shows the fishing rod simply laid down along the side of a boat. Neither device incorporates a means to adjust the pulling power or pulling length produced by the jigging device. Additionally both devices require the addition of a solid mounting platform to securely hold the jigging device. Lastly, neither design is intended for fish weighing more than a few pounds.

Before being placed in use, the operator must first install the jigging device in a location where such a device can be firmly mounted to an adjacent structure. This may require cutting and/or drilling into the vessel's structure. Should it prove advantageous to provide additional locations for the jigging device, Further cutting and/or drilling of the vessel′ structure may be required. Additionally, the jigging device must be installed in a location where it does not interfere with normal pedestrian traffic but is still readily accessible to the fisherman. Often, these basic requirements are difficult to meet, especially when installed on a boat. Where the fishing rod itself is jigged as is the case in almost all the prior art, jigging the fishing rod further complicates the search for a secure location where the whipping back-and-forth of the fishing rod will not cause damage to equipment or operators.

With the present art, the motorized jigging device must be securely mounted to eliminate wasted movement when the unit is in operation. Any movement which is not transmitted to the jigging operation subtracts from the effectiveness of the jigging device. Therefore, the present art bolts or otherwise securely fastens the jigging device to the boat structure. To install the unit and then remove it after each use would require work with tools. The disadvantage of leaving the unit in place is that the jigging device is best removed from the vessel after being used. This keeps the jigging device out of the weather for most of its useful life and removes the potential for theft

Lastly, missing from the present designs is the ability to easily and simply adjust the pulling power of the jigging device, and the distance the bait or lure is pulled with each cycle. This is critical if the full advantages of the jigging operation is to be realized. Existing designs do not allow for the use of the same jigging device to be easily adaptable for trolling for marlin or bottom fishing for small bass.

### SUMMARY OF THE INVENTION

The present disclosure is directed to a powered jigging device which does not hold the fishing rod as is the case with almost all of the prior art. Instead, the jigging device clips to the fishing line a distance past the rod tip in the direction of the lure or bait being jigged. Additionally; the jigging device is designed to provide a solid mounting base when installed in a fishing vessel's existing rod holder. Such rod holders may also be found wherever it is desirable to firmly and securely hold a fishing rod. Permanently installed rod holders are common on fishing boats and are normally installed by the vessel manufacturer. These rod holders are simple devices, basically consisting of a strong metal tube which may be flange-mounted to along the vessel's railing or welded/bolted in key locations around the vessel's helm (steering area). They are built and installed to handle large loads. Typical manufacturers include Amarine, Hoffen and Brocraft. It is common practice for fishermen to leave the fishing rod in the rod holder while fighting a fish. For this to be practical, a standard rod holder as described here-in will need to remain functional and undamaged even when the rod it holds is connected to a very angry 1,000 lb marlin. Although designed for large loads, similar but lighter duty rod holders may also be installed along the railing of a pier or on a table or bench for ice fishing. The intent of the present disclosure is to present a powered jigging device which may be firmly and securely mounted into such an existing rod holder. When so mounted, the jigging device shall be capable of being adjusted to present the optimum jigging performance while being positioned out of the way of the normal functioning of the vessel or personnel using the jigging device. Lastly, the jigging device will be capable of being easily adjustable to provide sufficient power to cover the requirements of a wide range of the weights being jigged.

A typical rod holder which is permanently and securely mounted to a fishing vessel's structure and is normally used for either storing a fishing, rod or for securely holding a fishing rod currently employed in trolling a lure or bait. Typically, a fishing boat will have between two and 12 or more such rod holders. All such rod holders have some commonalities: they consist of a cylinder into which a fishing rod is inserted and a bar at the base of the cylinder over which the base of the fishing rod is slipped. The typical trolling fishing rod used for larger ocean fish has a groove or slot at its base specifically designed to slip over the bar installed through the lower end of the rod holder cylinder. So attached, the fishing rod cannot rotate when correctly installed in the rod holder. However, with the exception of these common design traits, existing rod holders may vary significantly in the length and diameter of the rod holder tube. Additionally, this tube may be a straight tube of constant diameter, or the tube may be tapered, having the largest diameter where the fishing rod is inserted and tapering down to a smaller diameter where the rod end slips over the bar near the end of the rod holder cylinder. Furthermore, an existing rod holder will most often be permanently and securely installed on the vessel at a significant angle. A typical rod holder installed on a vessel will hold a fishing rod such that the rod leans toward the stern of the boat.

In the present embodiment, the jigging device's mounting system has been designed to adapt easily to the differences in the designs of typical rod holders. When adjusted and installed into an existing rod holder, the jigging device shall neither jiggle back-and-forth nor rotate within the rod holder. Any such movement detracts from the full force and movement desired in the jigging process. In the present disclosure, the portion of the jigging device which attaches to the rod holder is constructed of two primary parts: A cylindrical tapered plug and a threaded rod. The larger end of the tapered plug has a diameter slightly larger than the largest inside diameter of the commercially available rod holders. The opposite end is slightly smaller than the smallest inside diameter of a commercially available rod holder. Should the tapered plug be inserted into any commercially available rod holder, it would slide into the rod holder cylinder until it wedged tightly against the inner wall of the rod holder cylinder.

The small end of the tapered plug is bored and tapped with standard straight female threads. The second primary part of the mounting design, the threaded rod, is threaded into the small end of the tapered plug. Grooves or slots are cut into the end of the opposing end of the threaded rod and designed to match those found on a fishing rod's base. To securely attach the base of the power jig assembly (tapered plug with threaded rod), the rod is screwed into the tapered plug a short distance and then this assembly is inserted into the existing rod holder until a groove at the base of the threaded rod slips over the bar at the base of the existing rod holder. A slight downward pressure is then applied to the tapered plug to urge the assembly into the rod holder while turning the tapered plug clockwise until it wedges itself tightly against the inner wall of the rod holder cylinder. At this point, the two parts are withdrawn from the rod holder and a small set screw inserted through the wall of the tapered plug and into the threaded bar. The tapered plug is provided with a recessed drilled hole such that the end of the set screw will be flush with the face of the tapered plug.

After providing a solid and secure mounting for the jigging device using an existing rod holder, the remainder of the jigging device is devoted to two objectives: (1) The relative position of the jigging device above the rod holder must be adjustable and (2) the jigging device must include a motorized sweep which pulls the fishing line backward and forward and can be adjustable to meet both the pulling weight and length-of-pull requirements.

The relative position of the jigging device above the rod holder is important for two reasons reasons. Firstly, most, rod holders slant toward the back of the boat and the addition of the jigging device may get in the way people. This will especially true for rod holders which are commonly found attached to the boat structure behind seating. A equipment base provides a mounting base for the jigging device's motor drive. The equipment base has provision for a mounting bolt at one end. The large end of the tapered plug is bored to accept this mounting bolt and the equipment base can be rotated around the large end of the tapered plug. The portion of the jigging device above the rod holder may therefore be rotated away from any potential interference. Additionally, if the rod holder used is above normal head height, the portion of the jigging device above the rod holder may be rotated downward to a position to where it can be easily accessed.

Secondly, the position of the jigging device relative to the rod holder is important to obtain the optimum performance of the jigging device. The jigging action is obtained using a wand which has one end attached to a motor's spindle. The specified motor for the jigging device is a marine windshield wiper motor. Operation of the motor causes the wand to oscillate backward and forward. A clip is situated along the wand and provides an attachment point for the fishing line. To get the maximum pulling length from this design, the wand must be perpendicular to the fishing line when the wand is half-way through its sweep. To allow for the position of the wand to be changed relative to the rest of the jigger assembly, the wand is attached to the motor's spindle drive shaft with a clamp. Once the equipment base holding the motor drive has been rotated into its optimum position, the wand is rotated around the motor drive spindle to obtain it's full pulling potential.

The author's installation of the jigging device is offered as an example of the flexibility offered by the design in installing the unit: The author's vessel was manufactured with four adjacent rod holders welded along a rail located above the helm (steering area). These rod holders are about seven feet above the deck and are installed by the vessel's manufacturer simply to store fishing rods out of the way. The jigging device is solidly installed into one of these rod holders as described above. The assembly is then rotated until the equipment base holding the motor drive is about horizontal to the deck and the electrical switch installed as part of the jigging device is readily accessible. The wand is then rotated around the sleeved spindle until it points directly at the deck when it is halfway through its cycle. Correctly done, the bottom end of the wand is just above six feet from the deck at its lowest point. As the author is just under six feet tall, the clip on the wand is easily accessible to attach the fishing line while the entire assembly is out of the way.

Adjusting the pulling force and the length of the jigging stroke is key to adapting the jigging device to different fishing styles. The jigging device uses a sleeve which is designed to easily slide along the entire length of the wand. Onto the sleeve is attached a clip which will hold the fishing line. Lastly, the sleeve is fitted with a thumbscrew which, when tightened, anchors the sleeve to the wand without moving. For a drive motor having an approximate rated torque of about 5.7 newton-meters, the following table shows the different pulling loads which may be obtained by simply moving the clip mounting sleeve along the wand starting at 7 cm from the gear drive spindle axis.

| | ALLOWABLE |
|---|---|
| DISTANCE FROM AXIS | LOAD (‘PULL’) |
| 8 cm | 71 newtons |
| 14 cm | 41 newtons |
| 21 cm | 27 newtons |
| 28 cm | 20 newtons |
| 35 cm | 16 newtons |
| 42 cm | 14 newtons |

The length of the pulling stroke will vary as the clip mounting sleeve is moved along the wand's length. Some styles of fishing require short jigging strokes. For this requirement, the clip mounting sleeve would be positioned fairly close to the wand's rotation axis. Where a longer stroke and faster movement is required, the clip mounting sleeve is positioned on the wand further away from the wand's axis of rotation.

This summary is provided to introduce a selection of features and concepts of embodiments of the present disclosure. These are further described below in the detailed description. This summary is not intended to identify key or essential features of the claimed subject matter, nor is it intended to be used in limiting the scope of the claimed subject matter. One of more of the described features may be combined with one or more other described features to provide a workable device.

### BRIEF DESCRIPTION OF THE SEVERAL VIEWS OF THE DRAWING

These and other features and advantages of embodiments of the present disclosure will become more apparent by reference to the following detailed description when considered in conjunction with the following drawings. In the drawings, like reference numerals are used throughout the Figures to reference like features and components. The Figures are not necessarily drawn to scale.

FIG. 1A is a view of the entire device showing the parts required for assembly according to one embodiment of the present disclosure;

FIG. 1B is a view of the assembled device according to one embodiment of the present disclosure;

FIG. 2 is a view showing the method for anchoring the mounting portion of the jigging device into an existing rod holder according to one embodiment of the present disclosure;

### DETAILED DESCRIPTION

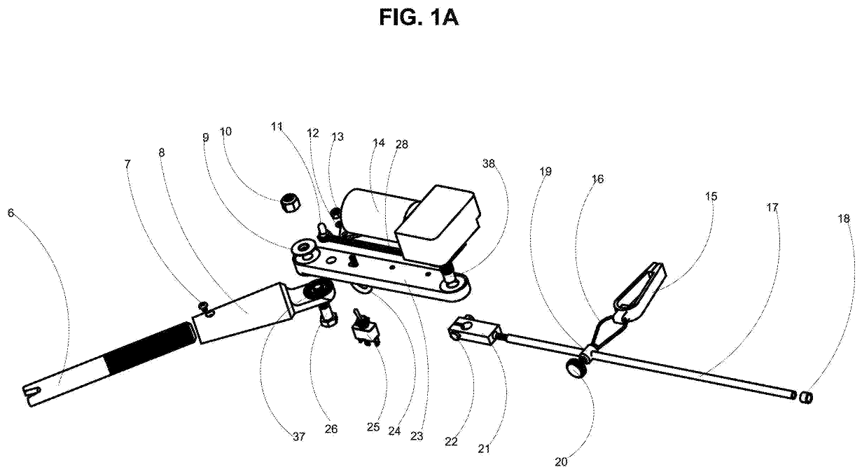

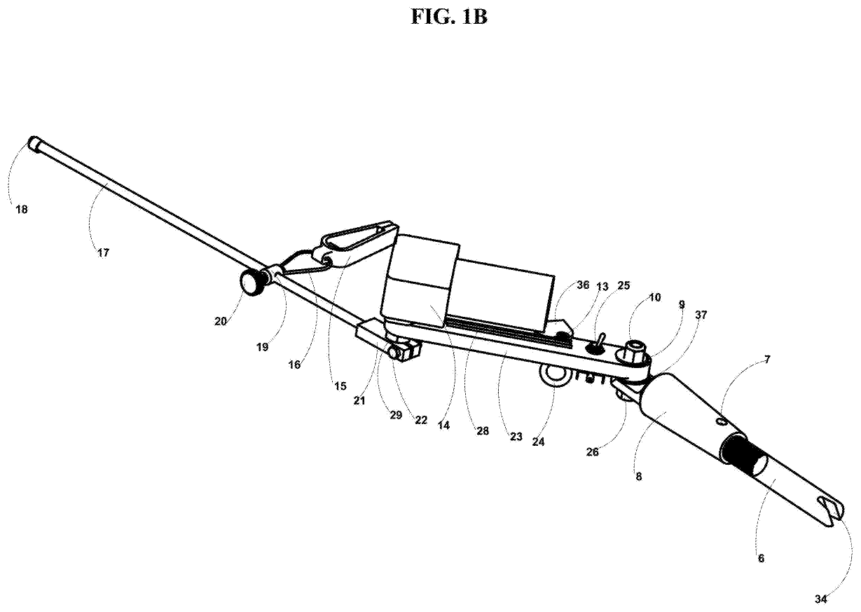

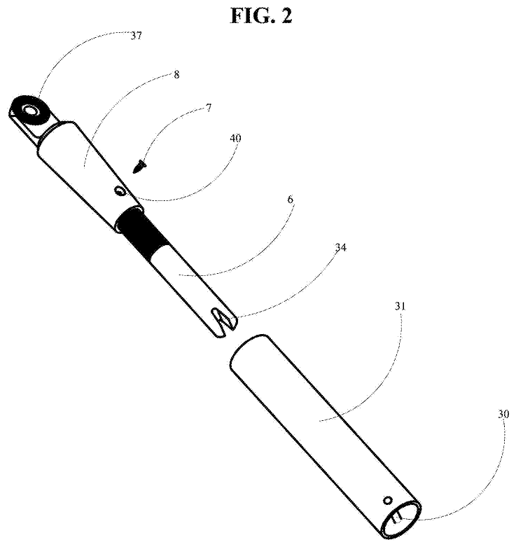

The present disclosure is directed to various embodiments of a powered jigging device. This narrative will begin with a description of the jigging device's elements which allow it to be securely and firmly mounted into an existing rod holder as indicated on FIG. 2. The individual parts comprising the assembled device will then be presented and indicated on FIG. 1A and FIG. 1B. Finally, the operation of the assembled device will be discussed.

FIG. 2 indicates the mounting portion of the jigging device, consisting of a tapered plug 8 an adjustment rod 6, and a set screw 7. The tapered portion of the tapered plug 8 has a small diameter which is slightly larger than the diameter of the adjustment rod 6 or approximately 3.2 cm. The tapered portion of the tapered plug is about 200 cm long and with the taper ending at a larger diameter of about 6.4 cm. These dimensions are presented as an example and may be altered should larger diameter and/or longer rod holders be made available. The upper end of the tapered plug 8 includes a hole drilled perpendicular to the long axis of the tapered plug 8. This hole is provided such that the tapered plug 8 may be bolted to the equipment base 23 shown in FIGS. 1A and 1B. A circular raised extrusion about 0.3 cm high is provided concentric to this bolt hole and consists of a non-skid surface 37. A matching non skid surface is included on the equipment base 23 at the point the equipment base 23 bolts to the tapered plug 8. The opposite end of the tapered plug 8 is drilled and internally threaded along its long axis. These female threads extend up to approximately 1.3 cm from the large diameter end of the taper or about 19.2 cm.

An adjustment bar 6 consists of a round bar, having a diameter less than the inside diameter of the smallest commercially available rod holder. This will require a diameter for the adjustment bar 6 of approximately 2.6 cm. The overall length of the adjustment bar 6 is determined by the maximum length of a typical commercial rod holder. One end of the adjustment bar 6 is male threaded to match the internal female threads provided in the tapered plug 8 and will at least 19 cm in length. A sloping groove 34 is provided at the opposite end of the adjustment bar 6. The sloped groove 34 begins with a width of about 1.3 cm and ends in a diameter which is slightly less than 0.65 cm. The length of the groove is approximately 2.6 cm long.

Standard rod holders which are designed to be permanently mounted on fishing vessels vary considerably in length and diameter. However, they all normally share the common characteristics of a tube having a round bar 30 factory installed close to the lower end of the tube. The ability of the jigging device's mounting system to conform to these variations while providing a tight and secure base when inserted into the existing rod holder is a key element in this embodiment.

The adjustment rod 6 is initially threaded into the tapered plug 8 a distance of approximately 2.6 cm. This assembly of the two parts is then inserted into an existing rod holder 31 beginning with the grooved end 34 of the adjustment bar 6 until the grooved end 34 slips over and seats against the round bar 30. A slight downward pressure is then applied continually to the tapered plug 8 for the purpose of maintaining the seating of the grooved end 34 firmly over the round rod 30. The tapered plug 8 is then rotated around its long axis such that the tapered plug enters and finally seats firmly against the inner wall of the existing rod holder 31. The equipment base 23 is then loosely fastened to the tapered plug 8 and the tapered plug further rotated in the same direction until the equipment base 23 is properly oriented for the desired jigging operation. The assembly is then carefully removed from the existing rod holder 31 and the set screw 7 is installed into the set screw hole 40 and extends into the adjustment bar 6 approximately 1.3 cm. It should be noted that a threaded nut would appear to be a better choice when locking the adjustment bar 6 to the tapered plug 8. This would work and would be a more simple solution. However, It was found during the testing trials for the jigging device, that significant torque was applied to the tapered plug 8 when a large fish struck the fishing line. The set screw 7 was determined to be the better option for contending with this load. The same jigging device may be easily adapted to numerous rod holders simply by removing the set screw 7 and correctly adjusting the jigging device to another rod holder before re-installing the set screw 7.

The motor 14 is then firmly attached to the equipment base 23. The equipment base is typically about 27.5 cm long, 3.8 cm wide and 1.6 cm thick with rounded ends. A standard 12 volt direct current marine windshield wiper motor is specified as the drive motor for this device. While the present embodiment may be constructed and operated with a number of different drive motors, a marine windshield wiper motor has a number of inherent advantages when employed in this jigging device. Such a motor normally is equipped with an integral gear box which allows for the sweep angle of the wiper blade to be adjustable. The angle made by the wiper blade (sweep angle) may be as great as 110 deg. or a little as 45 deg. for a typical unit. Thus the distance of the jigging stroke is adjustable with-in the motor's gear box. Along with the standard on-off control, the wiring for such a unit may include provision for high and low speeds. High speed may be in the range of about one second for a complete backward and forward sweep with low speed dropping to about 1.5 seconds for the same movement. Such units also normally provide provision to electrically ‘park’ the wiper blade in a desired position. Lastly, while most windshield wiper motors may be adapted for use with the jigging device, a unit specifically rated for marine usage is very advantageous in the potentially wet environment for which the jigging device has been designed. Examples of typical marine windshield wiper motors which would work well with the present embodiment are the Ongaro Heavy Duty marine 2-Speed Wiper Motor, the Five Oceans Heavy Duty Wiper Motor, and a Wexco Marine Wiper Motor.

The mounting of a typical windshield wiper motor is shown on FIGS. 1A and 1B. The mounting requirements for the motor 14 will vary with each different motor used in the assembly. However, most windshield wiper motors will have at least a mounting plate 36 toward the rear of the motor to allow the unit to be bolted to a base and a sleeved spindle 38 which allows the opposite end with the gear drive to be further attached to a base. The sleeved spindle 38 typically consists of the motor drive shaft which rotates within an externally threaded tube and extends about 1.3 cm beyond the end of the threaded tube. An eye bolt 24 is the preferred method attaching the mounting plate 36 to the equipment base 23 with a flat washer 12 and lock nut 13. A hole is provided on the opposing end of the equipment base 23 through which the motor's sleeved spindle 38 is inserted. The spindle nut 29 shown on FIG. 1B is threaded over the end of the sleeved spindle 38 and clamps the front end of the motor 14 to the equipment base.

The gear drive's rotating spindle extends out from this sleeve and forms the attachment point for the wand clamp 21. The wand 17 and the wand clamp 21 takes the place of the windshield wiper for which the motor 14 was originally designed. The portion of the wand clamp 21 which slips over the exposed end of the sleeved spindle 38 is designed as a clamp and tightened onto the spindle with the bracket clamp bolt/nut 22. Initially, the wand clamp 21 is loosely clamped to the end of the sleeved spindle 38 as the ability to adjust the wand bracket's position in respect to the sleeved spindle is a key advantage in properly orienting the final assembly.

The end opposite the bolt on the wand bracket is drilled and tapped to accept the male threaded end of the wand 17. The wand 17 is a round rod, approximately 50 cm in length and having a diameter of about 1.0 cm. A dip mounting sleeve 19 slips over the wand 17 and is designed to slide easily along the length of the wand 17. A sleeve thumb screw 20 is threaded into one end of the dip mounting sleeve 19 and when tightened until it's threaded end bears up against the wand, anchors the dip mounting sleeve 19 to the selected location along the length of the wand 17. A swivel joint 16 is attached to the end of the dip mounting sleeve 19 opposite the sleeve thumb screw 20. A standard commercial fishing line dip 15 (Scotty #1182 Mini Power Grip or similar) is attached to the swivel joint. A fishing line dip is roughly similar in operation to a common clothes line dip. However, its clamping ability is much greater and normally is adjustable in two stages between standard clamping force and tight clamping force. To open the clamp jaws, an operator compresses the two sides of the dip inward together. This fishing line dip 15 will be used with the jigging device to clamp onto the fishing line being jigged. Lastly, a wand end cap 18 is permanently affixed at the end of the wand shaft to prohibit the dip mounting sleeve 19 from sliding off the end of the wand 17.

The operation of the motor is controlled by a marine electrical switch 25. It is often advantageous to have the controlling switch located in close proximity to the unit being controlled and the present embodiment indicates a recessed cavity cut into the equipment base 23 for the purpose of housing the electrical switch 25. The switch is selected based on the level of control desired by the operator. A switch which provides on-off control along with high or low speeds when turned on is one example. An alternate example would be a switch which, when turned off, parked, the wand assembly in a location where the operator could readily access the fishing line clip 15. Additionally, the operator may choose to install the electrical switch in an area remote from the jigging device's location such as at the helm (steering area). An electrical switch installed in a marine environment often will be installed with a weather-proof switch cover 11 over the switch arm as indicated on FIG. 1A. Power to the device will normally be 12 volt direct current. A simple two prong electrical plug may be employed where the power from the vessel attaches to the jigging device's electrical service. This allows for the jigging device to be easily disconnected and stored in an alternate location.

Materials used in construction should be those typically employed in equipment intended to be exposed in a marine environment. Additionally, a marine grade plastic, having a high impact resistance and not being adversely affected by exposure to sunlight is the preferred construction material for the adjustment bar 6, the tapered plug 8 and the equipment base 23. These three parts constitute the majority of the expense in fabricating the jigging device and considerable cost saving may be realized should standard 3D printing be used to produce the parts. The wand 17 needs to be fairly rigid and thick-walled 300 series stainless steel tubing is an acceptable choice. Fasteners should be either 304 or 316 stainless steel and all nuts should be nylon insert type lock nuts.

### Operation of the Jigging Device

One of the major advantages inherent with the present embodiment is its ability to be configured both to avoid being an interference to personnel and to achieve the optimum jigging performance. For example, should the jigging device be installed into an existing rod holder located behind the helm seating, the sweep operation of the wand 17 will be adjusted so as not to strike an occupant. Additionally, should the jigging device be installed in a location above the steering area, the jigging device must be configured such that the operator can easily access the fishing line clip 1 and/or the electrical switch 25.

Two pivot points with-in the jigging device provide a simple and structurally sound method for properly configuring the installation of the jigging device. The jigging device is initially adjusted and secured in an existing rod holder as described in the beginning of this section. The equipment base 23 containing the electrical switch 25 and motor 14 is then rotated around its pivot point at the end of the tapered plug 8. The final rotation point of the assembly should position the assembly out of the way of personnel while providing easy access to the electrical switch 25. The rotation bolt 26 is then tightened securely with the main rotation flat washer 9 and main rotation lock nut 10 to retain the set position. A 13 cm diameter stainless steel bolt is typical for this embodiment. A large torque may be produced at this connection point when a fish strike occurs. To fully resist this torque, the mating surfaces between the equipment base 23 and the tapered plug 8 will normally require work beyond mere flat plastic or metal surfaces. The present embodiment uses a series of triangular teeth which radiate out from the center of the bolt hole on both the equipment base 23 and the tapered plug 8. When the two parts are joined, the teeth mesh and lock the two parts together. Forty sets of teeth allow the equipment base 23 to be rotated in nine degree increments around the end of the tapered plug 8.

The jigging device is then adjusted to take full advantage of the maximum length that the lure or bait can be pulled in the jigging action. This is easily set by taking advantage of the pivot point of the wand clamp 21 around the exposed end of the sleeved spindle 38. The wand clamp 21 is initially firmly attached to this end. The motor 14 is started and the wand clamp 21 will rotate back and forth. The motor 14 is stopped when the wand clamp 21 is half-way through a sweep. The wand clamp 21 is then removed from the spindle. The wand 17 is threaded into the wand clamp 21, and the wand clamp 21 is fitted loosely over the exposed end of sleeved spindle. The wand clamp 21 is then rotated until the wand will be roughly perpendicular to the fishing line being jigged. The wand clamp 21 is then securely tightened over the exposed end of the sleeved spindle 38. This method will provide the maximum backward and forward pulling length for the jigging action and can be re-adjusted whenever the jigging device is installed in an alternate location.

A second major advantage inherent in the present embodiment is its ability to be easily adjusted to meet different pulling loads. Optimum jigging performance is obtained by setting the jigging device to match or exceed the pulling force required by the lure or bait being jigged. The dip mounting sleeve 19 is moved along the length of the wand 17 until the required puffing force is achieved. Sliding the dip mounting sleeve 19 away from the wand end cap 18 and toward the wand clamp 21 increases the pulling force of the jigging device.

The jigging device is now prepared to lend its assistance in the fishing operation. The jigging device's fishing line dip 15 is clamped over the fishing line a short length from the tip of the fishing rod. Fishing vessel manufacturers commonly install a number of rod holders adjacent to or in close proximity of another rod holder. The clamping point for the fishing line is chosen such that when the fishing rod is placed is an adjacent rod holder, the action of the jigging device pulls the lure or bait and not the fishing rod tip. If the fishing rod tip is pulled, simply lengthen the length of fishing line between the rod tip and the fishing line clip 15. Sit back and watch the jigging device pull the lure or bait back and forth. When a fish strikes, the fishing line clamp 15 will automatically release its hold on the fishing line. Really large fish when hooked create a loud and exciting ‘Whap!’ from the jigging device.

### DRAWINGS—REFERENCED NUMERALS

| | | | |
|---|---|---|---|
| 6 | adjustment bar | 21 | wand damp |
| 7 | set screw | 22 | clamp bolt/nut |
| 8 | tapered plug | 23 | equipmentbase |
| 9 | main rotation flat washer | 24 | eye bolt |
| 10 | main rotation lock nut | 25 | electrical switch |
| 11 | weather-proof switch cover | 26 | main rotation bolt |
| 12 | flat washer | 28 | electrical wiring from motor |
| 13 | lock nut | 29 | spindle nut |
| 14 | motor | 30 | round bar |
| 15 | fishing line clip | 31 | existing rod holder |
| 16 | swivel joint | 34 | sloping groove |
| 17 | wand | 36 | motor mounting plate |
| 18 | wand end cap | 37 | non-skid surface |
| 19 | clip mounting sleeve | 38 | sleeved spindle |
| 20 | sleeve thumb screw | 40 | set screw hole |

### CONCLUSIONS, RAMIFICATIONS, AND SCOPE

The present, art in powered jigging devices falls far short of realizing the full potential that jigging offers a fisherman. The present embodiment of a powered jigging device extends the jigging advantage into ‘blue-water’ ocean fishing while still being fully adaptable to the less demanding loads imposed by lake fishing or in-shore fishing. Besides taking advantage of the vessel's existing rod holders to provide a strong and movement-free mounting base for the jigging device, there will be cost savings in using existing equipment to form the base for mounting the device. While the present art presents devices that cannot easily be adjusted to avoid interference with the operation of the vessel, the present embodiment of the jigging device is fully adjustable. The jigging device may be rotated away from potential obstructions and configured for optimum accessibility, control and performance. The functionality of the jigging device is further enhanced by its unique ability to be adjusted to meet the different load requirements as imposed by the lure or bait chosen to be jigged.

I claim:

1. A jigging device which will impart an oscillating motion to a fishing line. Said jigging device shah be comprised of:
a. A mounting base which fits into a wide variety of commercially available fishing rod holders. Said rod holders sharing the common characteristic of being generally cylindrical in shape and having a pin installed near the cylindrical base.
b. An equipment base which provides a secure platform for installing a motor and an electrical switch. Said equipment base being attached to the upper portion of the mounting base in such a manner that it can rotate around the attachment point and be clamped at the optimum rotation angle.
c. An electrical motor having a gearbox. Said motor shall be designed to rotate a spindle back-and-forth through a specific sweep angle.
d. A wand which has one end clamped to the motor spindle. Said wand shall be capable of being rotated around the motor drive spindle and firmly clamped in the desired location around the spindle.
e. A fishing line dip which is attached to the wand. The fishing line clip clips onto a fishing line and automatically releases the line when the line aggressively pulled.

2. The jigging, device of claim 1 characterized in that the motor having a gearbox is a windshield wiper motor.

3. The jigging device of claim 1 characterized in that the mounting system is comprised of an adjustment bar threaded into a tapered plug, the adjustment bar having a groove cut to fit over the factory-installed pin at the base of said rod holder.

4. The jigging device of claim 1 characterized in that a clip mounting sleeve is installed over the wand shaft such that said clip mounting sleeve may slide freely along the length of the wand shaft. The fishing line clip is attached to the clip mounting sleeve. A thumbscrew or similar device is installed in the clip mounting sleeve and provides a means by which the clip mounting sleeve may be firmly anchored in the selected location along the wand shaft.
